(19) United States
(12) Patent Application Publication
(10) Pub. No.: US 2024/0114485 A1
(43) Pub. Date: Apr. 4, 2024

(54) TECHNIQUES FOR RESOURCE RESERVATION IN SIDELINK COMMUNICATIONS

(71) Applicant: QUALCOMM INCORPORATED, San Diego, CA (US)

(72) Inventors: Anantharaman BALASUBRAMANIAN, San Diego, CA (US); Kapil GULATI, Belle Mead, NJ (US); Shuanshuan WU, San Diego, CA (US); Navid ABEDINI, Basking Ridge, NJ (US); Junyi LI, Fairless Hills, PA (US); Sourjya DUTTA, San Diego, CA (US); Hui GUO, Beijing (CN)

(21) Appl. No.: 18/257,551

(22) PCT Filed: Feb. 12, 2021
(86) PCT No.: PCT/CN2021/076631

§ 371 Date: Jun. 14, 2023

(51) Int. Cl. H04W 72/044; H04L 5/14

(52) U.S. Cl. CPC H04W 72/044; H04L 5/1461

(57) ABSTRACT

Methods, systems, and devices for wireless communication at a first user equipment (UE) are described. A first UE may transmit control signaling to reserve a first set of time and frequency resources for a sidelink transmission. In some examples, the control signaling may indicate one or more parameters to be used by a second UE to identify a second set of time and frequency resources for performing a full-duplex communication with the first UE. In some examples, the first UE may then communicate with the second UE based on the reserved first set of time and frequency resources and the indicated one or more parameters associated with the second set of time and frequency resources.

### CROSS REFERENCE

The present Application is a 371 national stage filing of International PCT Application No. PCT/CN2021/076631 by BALASUBRAMANIAN et al. entitled “TECHNIQUES FOR RESOURCE RESERVATION IN SIDELINK COMMUNICATIONS,” filed Feb. 12, 2021, which is assigned to the assignee hereof, and which is expressly incorporated by reference in its entirety herein.

### INTRODUCTION

The following relates to wireless communication at a user equipment (UE), including techniques for resource reservation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as UE.

### SUMMARY

A method for wireless communication at a first UE is described. The method may include transmitting control signaling to reserve a first set of time and frequency resources for a sidelink transmission. In some examples, the control signaling may indicate one or more parameters to be used by a second UE to identify a second set of time and frequency resources for performing a full-duplex communication with the first UE. The method may also include communicating with the second UE based on the reserved first set of time and frequency resources and the indicated one or more parameters associated with the second set of time and frequency resources.

An apparatus for wireless communication at a first UE is described. The apparatus may include a processor and memory coupled to the processor. The processor and memory may be configured to transmit control signaling to reserve a first set of time and frequency resources for a sidelink transmission. In some examples, the control signaling may indicate one or more parameters to be used by a second UE to identify a second set of time and frequency resources for performing a full-duplex communication with the first UE. The processor and memory may further be configured to communicate with the second UE based on the reserved first set of time and frequency resources and the indicated one or more parameters associated with the second set of time and frequency resources.

Another apparatus for wireless communication at a first UE is described. The apparatus may include means for transmitting control signaling to reserve a first set of time and frequency resources for a sidelink transmission. In some examples, the control signaling may indicate one or more parameters to be used by a second UE to identify a second set of time and frequency resources for performing a full-duplex communication with the first UE. The apparatus may further include means for communicating with the second UE based on the reserved first set of time and frequency resources and the indicated one or more parameters associated with the second set of time and frequency resources.

A non-transitory computer-readable medium storing code for wireless communication at a first UE is described. The code may include instructions executable by a processor to transmit control signaling to reserve a first set of time and frequency resources for a sidelink transmission. In some examples, the control signaling may indicate one or more parameters to be used by a second UE to identify a second set of time and frequency resources for performing a full-duplex communication with the first UE. The code may further include instructions executable by the processor to communicate with a second UE based on the reserved first set of time and frequency resources and the indicated one or more parameters associated with the second set of time and frequency resources.

Some examples of the method, apparatuses, and non-transitory computer-readable medium described herein may further include operations, features, means, or instructions for determining a bitmap including a set of bits indicating the second set of time and frequency resources supporting the full-duplex communication, In some examples, the one or more parameters may include the second set of time and frequency resources supporting the full-duplex communication.

Some examples of the method, apparatuses, and non-transitory computer-readable medium described herein may further include operations, features, means, or instructions for determining the second set of time and frequency resources based on applying a first resource separation value after a first time and frequency resource of the first set of time and frequency resources and a second resource separation value after a second time and frequency resource of the first set of time and frequency resources. In some examples, the one or more parameters may include the first resource separation value and the second resource separation value.

Some examples of the method, apparatuses, and non-transitory computer-readable medium described herein may further include operations, features, means, or instructions for determining the second set of time and frequency resources based on applying a threshold resource separation after each time and frequency resource of the first set of time and frequency resources. In some examples, the one or more parameters may include the threshold resource separation. In some examples of the method, apparatuses, and non-transitory computer-readable medium described herein, the threshold resource separation includes a threshold number of physical resource blocks or a threshold number of subbands or both.

Some examples of the method, apparatuses, and non-transitory computer-readable medium described herein may further include operations, features, means, or instructions for determining at least one receive transmission configuration indicator state for the second set of time and frequency resources supporting the full-duplex communication at the first UE. In some examples, the one or more parameters may include the at least one receive transmission configuration indicator state.

In some examples of the method, apparatuses, and non-transitory computer-readable medium described herein, the at least one receive transmission configuration indicator state indicates an absolute beam direction or a relative beam direction with respect to a current transmit beam direction. Some examples of the method, apparatuses, and non-transitory computer-readable medium described herein may further include operations, features, means, or instructions for calculating a self-interference between a transmit chain and a receive chain at the first UE and determining a reference signal received power threshold based on the calculated self-interference. In some examples, the one or more parameters may include the reference signal received power threshold.

Some examples of the method, apparatuses, and non-transitory computer-readable medium described herein may further include operations, features, means, or instructions for determining a distance threshold based on a self-interference between a transmit chain and a receive chain at the first UE, where the one or more parameters include the distance threshold.

In some examples of the method, apparatuses, and non-transitory computer-readable medium described herein, the second set of time and frequency resources includes a subset of the first set of time and frequency resources. In some examples of the method, apparatuses, and non-transitory computer-readable medium described herein, the first UE includes a subband full duplex UE or a single frequency full duplex UE.

A method for wireless communication is described. The method may include receiving control signaling from a UE. In some examples, the control signaling may reserve a first set of time and frequency resources for a sidelink transmission. In some examples, the control signaling may indicate one or more parameters to be used to identify a second set of time and frequency resources for performing a full-duplex communication with the UE. The method may further include communicating with the UE based on the indicated one or more parameters associated with the second set of time and frequency resources.

An apparatus for wireless communication is described. The apparatus may include a processor and memory coupled to the processor. The processor and memory may be configured to receive, from a UE, control signaling to reserve a first set of time and frequency resources for a sidelink transmission. In some examples, the control signaling may indicate one or more parameters to be used to identify a second set of time and frequency resources for performing a full-duplex communication with the UE. The processor and memory may further be configured to communicate with the UE based on the indicated one or more parameters associated with the second set of time and frequency resources.

Another apparatus for wireless communication is described. The apparatus may include means for receiving, from a UE, control signaling to reserve a first set of time and frequency resources for a sidelink transmission. In some examples, the control signaling indicating one or more parameters to be used to identify a second set of time and frequency resources for performing a full-duplex communication with the UE. The apparatus may further include means for communicating with the UE based on the indicated one or more parameters associated with the second set of time and frequency resources.

A non-transitory computer-readable medium storing code for wireless communication is described. The code may include instructions executable by a processor to receive, from a UE, control signaling to reserve a first set of time and frequency resources for a sidelink transmission. In some examples, the control signaling may indicate one or more parameters to be used to identify a second set of time and frequency resources for performing a full-duplex communication with the UE. The code may further include instructions executable by the processor to communicate with the UE based on the indicated one or more parameters associated with the second set of time and frequency resources.

Some examples of the method, apparatuses, and non-transitory computer-readable medium described herein may further include operations, features, means, or instructions for determining a bitmap including a set of bits indicating the second set of time and frequency resources supporting the full-duplex communication. In some examples, the one or more parameters include the set of bits indicating the second set of time and frequency resources supporting the full-duplex communication.

Some examples of the method, apparatuses, and non-transitory computer-readable medium described herein may further include operations, features, means, or instructions for determining that the one or more parameters include a first resource separation value and a second resource separation value. Some examples of the method, apparatuses, and non-transitory computer-readable medium described herein may further include operations, features, means, or instructions for determining the second set of time and frequency resources based on applying the first resource separation value after a first time and frequency resource of the first set of time and frequency resources and the second resource separation value after a second time and frequency resource of the first set of time and frequency resources.

Some examples of the method, apparatuses, and non-transitory computer-readable medium described herein may further include operations, features, means, or instructions for determining that the one or more parameters include a threshold resource separation. Some examples of the method, apparatuses, and non-transitory computer-readable medium described herein may further include operations, features, means, or instructions for determining the second set of time and frequency resources based on applying the threshold resource separation after each time and frequency resource of the first set of time and frequency resources. In some examples of the method, apparatuses, and non-transitory computer-readable medium described herein, the threshold resource separation includes a threshold number of physical resource blocks or a threshold number of subbands or both.

Some examples of the method, apparatuses, and non-transitory computer-readable medium described herein may further include operations, features, means, or instructions for determining at least one receive transmission configuration indicator state for the second set of time and frequency resources supporting the full-duplex communication at the UE. In some examples, the one or more parameters may include the at least one receive transmission configuration indicator state. In some examples of the method, apparatuses, and non-transitory computer-readable medium described herein, the at least one receive transmission configuration indicator state indicates an absolute beam direction or a relative beam direction with respect to a current transmit beam direction.

Some examples of the method, apparatuses, and non-transitory computer-readable medium described herein may further include operations, features, means, or instructions for receiving, from the UE, a reference signal received power threshold. Some examples of the method, apparatuses, and non-transitory computer-readable medium described herein may further include operations, features, means, or instructions for determining the second set of time and frequency resources based on the reference signal received power threshold. Some examples of the method, apparatuses, and non-transitory computer-readable medium described herein may further include operations, features, means, or instructions for receiving, from the UE, a distance threshold and determining the second set of time and frequency resources based on the distance threshold.

In some examples of the method, apparatuses, and non-transitory computer-readable medium described herein, the second set of time and frequency resources includes a subset of the first set of time and frequency resources. In some examples of the method, apparatuses, and non-transitory computer-readable medium described herein, the UE includes a subband full duplex UE or a single frequency full duplex UE.

### BRIEF DESCRIPTION OF THE DRAWINGS

FIG. 1 illustrates an example of a wireless communications system that supports techniques for resource reservation in sidelink communications in accordance with one or more aspects of the present disclosure.

FIG. 2 illustrates an example of a wireless communications system that supports techniques for resource reservation in sidelink communications in accordance with one or more aspects of the present disclosure.

FIG. 3 illustrates an example of a resource pool that supports techniques for resource reservation in sidelink communications in accordance with one or more aspects of the present disclosure.

FIG. 4 illustrates an example of a process flow that supports techniques for resource reservation in sidelink communications in accordance with one or more aspects of the present disclosure.

FIGS. 5 and 6 show block diagrams of devices that support techniques for resource reservation in sidelink communications in accordance with one or more aspects of the present disclosure.

FIG. 7 shows a block diagram of a communications manager that supports techniques for resource reservation in sidelink communications in accordance with one or more aspects of the present disclosure.

FIG. 8 shows a diagram of a system including a device that supports techniques for resource reservation in sidelink communications in accordance with one or more aspects of the present disclosure.

FIGS. 9 through 13 show flowcharts illustrating methods that support techniques for resource reservation in sidelink communications in accordance with one or more aspects of the present disclosure.

### DETAILED DESCRIPTION

A wireless communications system may support both access links and sidelinks for communications between one or more communication devices. An access link may refer to a communication link between a UE and a base station. For example, an access link may support uplink signaling, downlink signaling, connection procedures, etc. A sidelink may refer to any communication link between similar wireless devices (e.g., a communication link between UEs, or a backhaul communication link between base stations). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

Sidelink communications may support communications within a group of UEs. For example, sidelink communications may include communications between a UE and one or more other UEs within a coverage area. In some examples, the coverage area may include the group of UEs (e.g., a coverage area provided by a base station, a coverage area outside of the coverage area provided by the base station, or a combination thereof). One or more of the UEs in the group of UEs may initiate sidelink communications with other UEs in the group of UEs. In some examples, V2X communication may support two modes of resource allocation mechanism. In a first mode of operation (e.g., mode 1), resources may be scheduled by a base station. In a second mode of operation (e.g., mode 2), base stations may not be involved in sidelink communications and a UE may perform autonomous resource selection. For example, a UE may reserve a set of resources without a base station allocating resources to UEs participating in sidelink communications. In the second mode of operation (e.g., mode 2), each transmitting UE performs a sensing operation to find occupied and/or available resources for its own transmission. Additionally or alternatively, when transmitting in a current slot, a transmitting UE may reserve a number of resources in a number of future slots.

A sidelink communications system may support full-duplex communications for increased spectral efficiency. One or more aspects of the present disclosure may provide for a full-duplex capable UE to simultaneously perform transmission and reception on a common set of time and frequency resources. In particular, aspects of the present disclosure provide for a transmitter UE (e.g., a UE having the capability to perform full-duplex communications) to determine that the transmitter UE is capable of performing transmission and reception on a set of time and frequency resources. The transmitter UE may indicate the set of time and frequency resources to a receiver UE. For example, in sidelink communications systems, a transmitter UE may determine whether the transmitter UE is capable of performing full-duplex communication on the set of time and frequency resources (i.e., capable of performing simultaneous bi-directional communication on the set of time and frequency resources). In some examples, the transmitter UE may be capable of transmitting on a first set of frequency resources and receiving on a second set of frequency resources. The first set of frequency resources and the second set of frequency resources may overlap in time and may span different frequencies. Additionally or alternatively, the transmitter UE may be capable of sending a transmission to a second UE and receiving another transmission from a third UE over the same time and frequency resources.

According to one or more aspects, a transmitter UE may indicate resource reservations reserving time and frequency resources for performing sidelink transmission in future slots. In one example, a transmitter UE may reserve a set of resources (e.g., {a₁, a₂, . . . aₘ}) to perform sidelink transmission during upcoming time slots. The transmitter UE may be capable of transmitting as well as receiving on a subset of the set of reserved time and frequency resources. For example, the subset of the set of reserved time and frequency resources may be referred to as full-duplex capable time and frequency resources. Upon determining that the transmitter UE is capable of simultaneously performing transmission and reception (e.g., at the same time) on some (e.g., a subset) of the reserved resources, the transmitter UE may indicate one or more parameters to be used by other UEs in determining the full-duplex capable time and frequency resources. That is, at least a second UE, upon receiving the parameters, may use the parameters to determine that the transmitter TE is capable to perform full-duplex communication on the subset of time and frequency resources. In particular, a receiving TE may receive the one or more parameters from the transmitter UE. The receiving TE may then use the one or more parameters to determine time and frequency resources (e.g., a subset of the set of resources {a₁, a₂, . . . aₘ}) over which the transmitter TE may perform bi-directional communication. The receiving TE may use the determined set of time and frequency resources to communicate with the transmitter UE.

UEs supporting full-duplex communications in sidelink communications systems may utilize the techniques described herein to experience power savings and extended battery life while ensuring reliable and efficient communications in the group of UEs. Particular aspects of the subject matter described in this disclosure may be implemented to support high reliability and low latency communications, among other examples. The described techniques may thus include features for improvements to power consumption, spectral efficiency, higher data rates and, in some examples, may promote efficiency for high reliability and low latency operations, among other benefits.

Aspects of the disclosure are initially described in the context of wireless communications systems. Aspects of the disclosure are further described in the context of a resource pool and a process flow. Aspects of the disclosure are further illustrated by and described with reference to apparatus diagrams, system diagrams, and flowcharts that relate to techniques for resource reservation in sidelink communications.

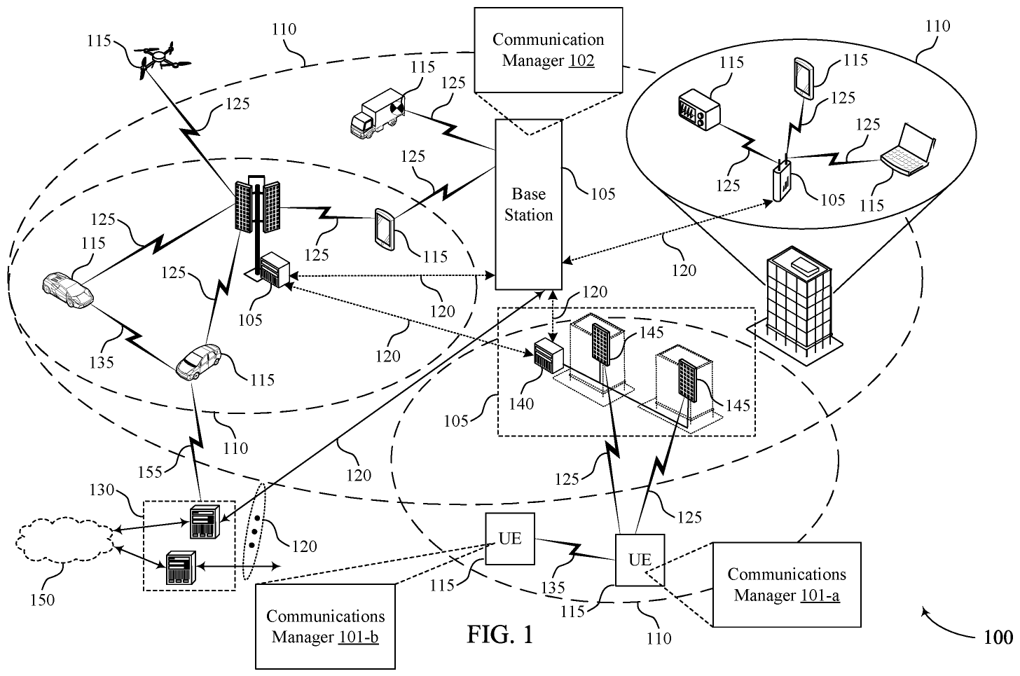

FIG. 1 illustrates an example of a wireless communications system 100 that supports techniques for resource reservation in sidelink communications in accordance with one or more aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band

Signal waveforms transmitted over a carrier may be made up of multiple subcarriers (e.g., using multi-carrier modulation (MCM) techniques such as orthogonal frequency division multiplexing (OFDM) or DFT-S-OFDM. In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). In some examples, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Some wireless communications system may support both access links and sidelinks for communications between one or more communication devices. An access link may refer to a communication link between a UE and a base station. A sidelink may refer to any communication link between similar wireless devices (e.g., a communication link between UEs, or a backhaul communication link between base stations). In some examples, some wireless communications systems may support two modes for resource allocation. In mode 1, a base station may allocate the resources for the UEs participating in sidelink communications. In mode 2, the UEs may perform autonomous resource selection. In some cases, a transmitting UE participating in sidelink communications may not be aware if another UE has upcoming data for transmissions. The transmitting UE may allocate time and frequency resources reserved for future transmissions to a receiver UE without knowing whether the receiver UE has upcoming data transmission. In wireless communications systems supporting V2X transmission, resources may be limited. It may be desirable for a transmitter UE to periodically poll a receiver UE identify if the receiver has data to send prior to scheduling resources for the receiver UE. As depicted herein, the UEs 115 may be examples of vehicles, mobile devices, vulnerable road users (VRUs), roadside units (RSUs), and the like. The UEs 115 may include a communications manager 101 configured to perform the various operations and techniques described herein.

According to one or more aspects of the present disclosure, the wireless communications system 100 may be configured to support techniques for resource reservation in sidelink communications. A first UE 115 may include a communications manager 101-a and a second UE 115 may include a communications manager 101-b. Additionally or alternatively, a base station 105 may include a communications manager 102. The communications manager 101-a, the communications manager 101-b and the communications manager 102 may implement one or more aspects of the present disclosure. In some examples, the base station 105 may use the communications manager 102 to transmit a resource allocation for one or more UEs. A first UE (e.g., transmitter device) may use the communications manager 101-a to transmit control signaling to reserve a first set of time and frequency resources for a sidelink transmission. In some examples, the control signaling may indicate one or more parameters to be used by a second UE to identify a second set of time and frequency resources for performing a full-duplex communication with the first UE. The second UE may use the communications manager 101-b to receive the control signaling and identify the one or more parameters. The first UE may communicate with the second UE (e.g., using the communications manager 101-a and the communications manager 101-b) based on the reserved first set of time and frequency resources and the indicated one or more parameters associated with the second set of time and frequency resources.

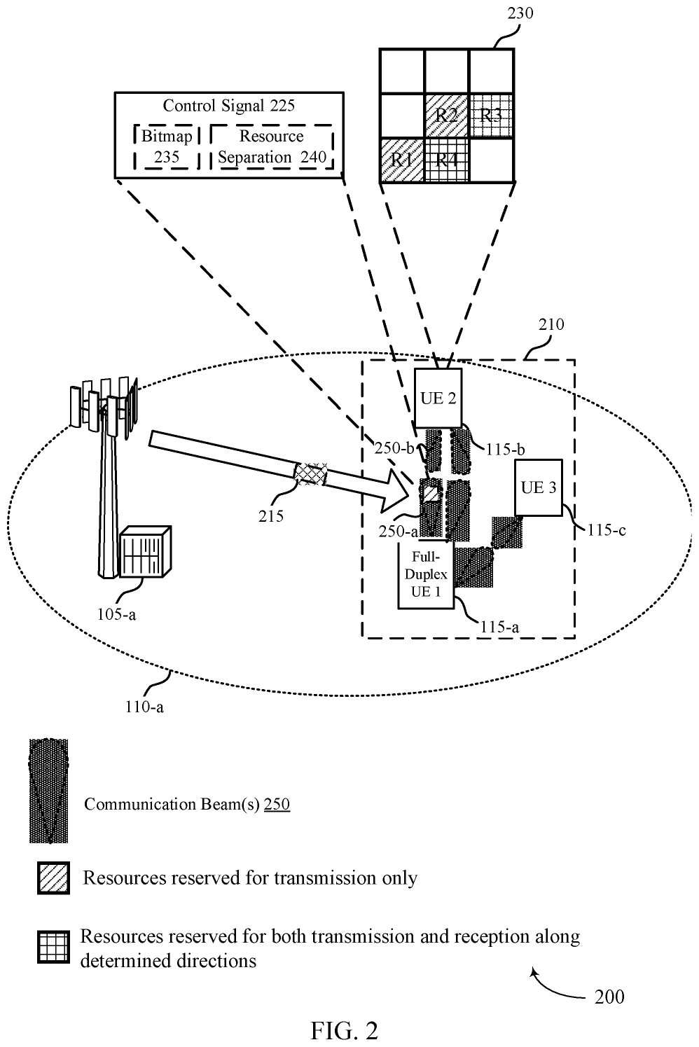

FIG. 2 illustrates an example of a wireless communications system 200 that supports techniques for resource reservation in sidelink communications in accordance with one or more aspects of the present disclosure. In some examples, the wireless communications system 200 may implement aspects of wireless communications system 100. The wireless communications system 200 includes base station 105-a, geographic coverage area 110-a, and one or more UEs 115 (may also be referred to as devices).

In some cases, the wireless communications system 200 may utilize control signaling to schedule resources for UEs 115 to perform sidelink communications. Additionally or alternatively, the UEs 115 in the wireless communications system 200 may utilize shared information to enhance scheduling, inter-UE coordination, and communications flexibility. In some examples, the group of UEs 115 (e.g., UE 115-a (UE 1), UE 115-b (UE 2), and UE 115-c (UE 3)) may communicate with each other (e.g., within a V2X system, a D2D system, and the like) and may employ sidelink transmissions to save power, reduce latency, and ensure reliable communications. In some examples, vehicles may communicate using V2X resource allocation mode 2 (that utilizes UE autonomous resource selection).

The wireless communications system 200 may support both access links and sidelinks for communications between one or more communication devices. An access link may refer to a communication link between a UE 115 (such as, UE 115-a, UE 115-b and UE 115-c) and a base station 105-a. A sidelink may refer to any communication link between similar wireless devices (e.g., a communication link between UEs, or a backhaul communication link between base stations). It is noted that while various examples provided herein are discussed for UE sidelink devices, such sidelink techniques may be used for any type of wireless devices that use sidelink communications. For example, a sidelink may support one or more of D2D communications, V2X or V2V communications, message relaying, discovery signaling, beacon signaling, or other signals transmitted over-the-air from one UE to one or more other UEs.

Base station 105-a may communicate with one or more UEs 115 (e.g., UEs 115-a, 115-b, and 115-c), which may be included within a UE group 210. For example, base station 105-a may transmit control information to the UE 115-a (UE 1), the UE 115-b (UE 2), or the UE 115-c (UE 3). As depicted in the example of FIG. 2, the UE 115-a, the UE 115-b, and the UE 115-c may communicate with each other (or with another group of UEs 115) over sidelink communications (e.g., using a peer-to-peer (P2P) or D2D protocol). In some cases, the UE 115-a may transmit sidelink transmissions to the UE 115-b or the UE 115-c. In some examples, UE 115-a or UE 115-b may monitor resource pools for the sidelink communications or indications of the sidelink communications (e.g., resource reservations, control channel transmissions, among other examples) from other UEs 115 in the group. Additionally or alternatively, the UEs 115 may have data to transmit to (or receive from) one or more of the UEs 115 in the group and may use the sidelink communications to transmit the data transmission. In some examples, the group of UEs 115 may utilize sidelinks communications in addition to access links with the base station 105-a.

In some examples, sidelink communications may support communications within a group of UEs 115 (e.g., group 210). For instance, sidelink communications may include communications between a UE (such as, UE 115-a, UE 115-b, and UE 115-c) and other UEs 115 within a coverage area including the group of UEs (e.g., a coverage area provided by a base station, a coverage area outside of the coverage area provided by the base station, or a combination thereof). One or more of the UEs 115 in the group of UEs 115 may initiate sidelink communications with other UEs in the group of UEs. For example, one or more of the UEs 115 may be in a coverage area 110-a (e.g., a coverage area 110 with reference to FIG. 1) of the base station 105-a. In such examples, a UE 115 may communicate with the base station 105-a via a Uu interface (e.g., the base station 105-a may transmit downlink communications to one or more of the UEs 115 via an access link). In some other examples, the group of UEs 115 may not be inside the coverage area or may not communicate with the base station 105-a using an access link.

In some cases, a UE 115 (such as, UE 115-a, UE 115-b, and UE 115-c) may have information (e.g., a detection of an object or obstacle on a road in a V2X system, scheduling information, among other examples) to transmit to the group of UEs 115, and the UE 115 may initiate sidelink communications including the information to the other UEs 115. In such cases, the UE 115 initiating the sidelink communications may be referred to as a transmitting UE and the UE 115 receiving the sidelink communications may be referred to as a receiving UE. In some examples, the base station 105-a may configure sidelink communication resources for the group of UEs using a configuration message (e.g., semi-persistent scheduling configuration message). In one example, the base station 105-a may communicate a control signaling 215 indicating a resource allocation for one or more UEs included in the group of UEs.

In some wireless communications systems, a UE from the group of UEs may be allowed to select sidelink transmission resources. In some examples, NR V2X communication may support two modes of resource allocation mechanism: Mode 1 (where the resource is scheduled by a base station) and Mode 2 (where the UE performs an autonomous resource selection). In case of Mode 2 operation, each transmitting UE may perform a sensing operation to find occupied or available resources for transmission. For example, devices (receivers and transmitters) may perform a sensing operation before transmitting.

In mode 2 operations, a transmitter device (e.g., UE 115-a or UE 1) may schedule resources for receiver devices (e.g., UE 115-b or UE 2). In particular, in case of mode 2 operation, each transmitting UE (e.g., UE 115-a or UE 1) may perform a sensing operation to find occupied and/or available resources for its own transmission. In some examples, when transmitting in current slot, a transmitting UE (e.g., UE 115-a or UE 1) may reserve a number of resources in a number of future slots. Sidelink communications systems may support full-duplex communications for increased spectral efficiency. In particular, increased spectral efficiency may be possible due to concurrent transmission and reception that will enable sidelink communications systems (e.g., wireless communications system 200) to share large payload (e.g., sensor sharing messages). In some wireless communications systems supporting full-duplex communications, there may be higher self-interference from transmission to reception (due to array leakage). With enhanced analog and/or digital cancellation techniques, wireless communications systems may be capable of managing self-interference.

In some wireless communications systems supporting autonomous resource allocation, resource reservation may also be supported. That is, a transmitting device (e.g., UE 115-a in the example of FIG. 2) when transmitting in current slot, may reserve a number of resources for a number of future slots. In some examples, the reserved resources for future time slots may be indicated by sidelink control information transmitted in a current transmission. The reserved resources may be used for retransmission of a transport block transmitted in the current transmission. Additionally or alternatively, the reserved resources may be used for new transport block transmission. When performing resource reservation, a transmitting device (e.g., UE 115-a or UE 1) may exclude resources that have been reserved by other communication devices. For example, in a V2X system supporting half duplex communications, a UE may keep monitoring transmissions from other UEs when it's not transmitting, so that the UE can receive resource reservation indication from other UEs. Different UEs may reserve different resources (e.g., subchannels) in one slot. That is, transmissions from multiple UEs may be multiplexed in a frequency division multiplexed manner.

In some wireless communications systems supporting full-duplex communications, some UEs may support full-duplex communications and some UEs may support half duplex communications. For instance, as vehicle UE have multiple transmission-reception points, there may be additional freedom to perform full-duplex and half-duplex sidelink communications (e.g., sidelink mmW communications). However, enabling full-duplex communication techniques in sidelink communications may be associated with one or more system updates. One or more aspects of the present disclosure provides a technique for a full-duplex capable UE to simultaneously perform transmission and reception on a common set of resources. In the example of FIG. 2, the UE 115-a may be a full-duplex UE. That is, the UE 115-a may be able to perform uplink communications and downlink communications (with different UEs) at the same time. In particular, aspects depicted herein may provide for a receiver UE (e.g., UE 115-b and UE 115-c in the example of FIG. 2) to infer an ability to perform transmission with a full-duplex capable UE (e.g., UE 115-a in the example of FIG. 2) when the full-duplex capable UE (or transmit UE) reserves future slots for a new transport block transmission or re-transmission. In some aspects, present disclosure may depict parameters associated with a full-duplex transmitter UE to be used by one or more receiver UE to be able to perform reliable full-duplex communications. Thus, even though the receiver UE may not be full-duplex capable, the receiver UE leverage the full-duplex capability of a transmitter UE to efficiently utilize the spectral efficiency of the wireless communications system 200 (e.g., V2X communications system).

As depicted in the example of FIG. 2, the UEs 115 may be configured with multiple antennas, which may be used for directional or beamformed transmissions (e.g., beamformed communication beams 250). For example, the UE 115-a may be configured with multiple antennas, which may be used for directional or beamformed transmissions (e.g., beamformed communication beams 250) to the UE 115-b and the UE 115-c. In some examples, the UEs 115 may transmit a number of beamformed communication beams 250 in different directions within a coverage area. In some examples, the UE 115-a may communicate with the UE 115-b and/or the UE 115-c on an active communication beam 250. The active communication beam may be used for transmitting a transmission, such as data and control information. The active communication beam may be a downlink receive beam and an uplink transmit beam for the UE 115-a, or a downlink transmit beam and an uplink receive beam for the UE 115-b, or a downlink transmit beam and an uplink receive beam for the UE 115-c.

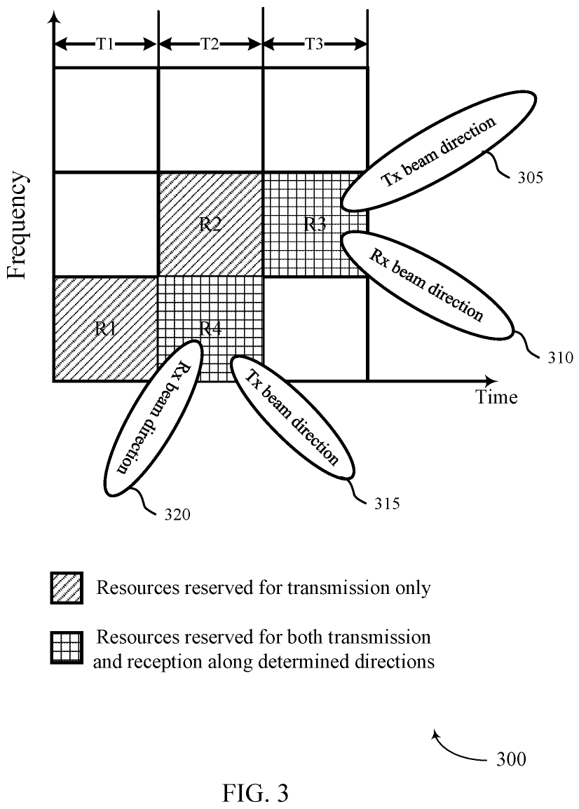

According to one or more aspects, a first UE 115-a (or UE 1) may transmit control signaling (using a communication beam 250-a) to reserve a first set of time and frequency resources for a sidelink transmission. In some examples, a second UE 115-b (or UE 2) may receive the control signaling 225 using a receive communication beam 250-b. The control signaling 225 indicating one or more parameters to be used by a second UE 115-b (e.g., UE 2) to identify a second set of time and frequency resources for performing a full-duplex communication with the first UE 115-a. The second UE 115-b may determine a resource pool 230 based on the control signal 225. As depicted in the example of FIG. 2, the first set of time and frequency resources may include resources R1, R2, R3 and R4 (as shown in resource pool 230). Additionally or alternatively, the second set of time and frequency resources may include resources R3 and R4. The resource pool 230 may be an example of a resource pool 300 as depicted with reference to FIG. 3. Using the control signal 225, the UE 115-a may indicate that the first UE 115-a has reserved a set of resources (e.g., resources R1, R2, R3 and R4) for communicating in future time slots. The first UE 115-a may also indicate the one or more parameters associated with the second set of time and frequency resources. The second UE 115-b, upon receiving the control signal 225, may construct the resource pool 230. That is, the second UE 115-b (or UE 2) may determine that the first UE 115-a has reserved resources R1, R2, R3 and R4 for performing transmission in future time slots, and resources R3 and R4 among resources R1, R2, R3 and R4 support bi-directional communication. In particular, the second UE 115-b may determine that the first UE 115-a may send transmissions (e.g., to UE 115-c) as well as receive transmissions (e.g., from UE 115-b) during the second set of time and frequency resources (e.g., resources R3 and R4). The first UE 115-a may then communicate with the second UE 115-a based on the reserved first set of time and frequency resources and the indicated one or more parameters associated with the second set of time and frequency resources. Thus, to indicate full-duplex capable resources to a receiver UE 115-b (e.g., second UE 115-b or UE 2), a transmitter UE 115-a may indicate resource reservations reserving resources for sidelink transmission in future slots.

In one example, the UE 1 may reserve a set of resources (e.g., {a₁, a₂ . . . aₘ} corresponding to resources R1, R2, R3 and R4) to perform sidelink transmission during future time slots. The UE 1 may determine that it has full-duplex capability (i.e., a capability to simultaneously perform transmission and various parameters to be used by other UEs (e.g., UE 115-b and UE 115-c) in determining the reserved resources which are full-duplex capable. In the example of FIG. 2, the UE 115-a (UE 1) may send downlink transmissions to the UE 115-c (UE 3) in parallel with receiving uplink transmissions from UE 115-b (UE 2) using a subset of the reserved resources.

In wireless communications system 200, a transmitter UE (e.g., UE 115-a) may be a subband full-duplex UE or a single frequency full-duplex UE. The UE 115-a (UE 1) may indicate resource reservations in future slots and the parameters to be used by the UE 115-b (UE 2) and/or the UE 115-c (UE 3) to perform full-duplex communication with the UE 115-a (UE 1) on one or more of the reserved resources. Although not depicted in the example of FOG. 2, it may be understood that the UE 115-b (UE 2) and/or the UE 115-c (UE 3) may be subband full-duplex UE or a single frequency full-duplex UE or a half-duplex UE. In one or more aspects, the UE 115-a may transmit control signal 225 (e.g., physical sidelink shared channel) indicating reservations in future slots. In some examples, the UE 115-a may reserve resource in future time slots for transmission of new packets. Additionally or alternatively, the UE 115-a may reserve resource in future time slots for re-transmission of one or more packets. For example, the UE 115-a (e.g., UE 1) receives a negative acknowledgment feedback for one or more packets associated with its original transmission that occurred between a current time and a time of the future reservation, the future reservation time slots can be used for re-transmission of one or more packets.

In some examples, the resources reserved by the UE 115-a may be denoted as {a₁, a₂, . . . aₘ} corresponding to resources R1, R2, R3 and R4 (as shown in resource pool 230), where {a₁, a₂, . . . aₘ} denotes one or more of subchannels, time and frequency resources, physical resource blocks, or a combination thereof. In some examples, for a set of resources which can be used for full-duplex communications, the UE 115-a may use a bit map 235 {b₁, b₂, . . . bₘ}. The bitmap 235 can be used for indication as a part of the control signal 225 transmitted to the UE 115-b and the UE 115-c. In some examples, the UE 115-a may determine a bitmap 235 including a set of bits indicating the second set of time and frequency resources (e.g., resources R3 and R4) supporting the full-duplex communication. As depicted in the example of FIG. 2, the one or more parameters included in or otherwise transmitted in conjunction with the control signal 225 may include the second set of time and frequency resources supporting the full-duplex communication. The UE 115-a may use the number “1” in a bitmap 235 to indicate the second set of time and frequency resources. In the example of FIG. 2, a first set of time and frequency resources may be {a₁, a₂, a₃, a₄} (e.g., resources R1, R2, R3 and R4). The UE 115-a may determine that among the first set of time and frequency resources {a₁, a₂, a₃, a₄}, the UE 115-a is capable of performing full-duplex communications (i.e., the UE 115-a is capable of simultaneously performing transmission and reception) on a second set of time and frequency resources {a₂, a₃}. In the example of FIG. 2, the second set of time and frequency resources {a₂, a₃} may correspond to resources R3 and R4 in the resource pool 230. The UE 115-a may then generate a bitmap {0, 1, 1, 0} indicating the second set of time and frequency resources {a₂, a₃}. The numbers “0” may indicate resources reserved by the UE 115-a and the numbers “1” may indicate the second set of time and frequency resources. For example, the a bitmap {0, 1, 1, 0} may indicate that the UE 115-a is capable of performing full-duplex communication on resources {a₂, a₃} (e.g., resources corresponding to the number “Is” in the bitmap).

Additionally or alternatively, the UE 115-a may determine the second set of time and frequency resources based on applying a first resource separation value after a first time and frequency resource of the first set of time and frequency resources and a second resource separation value after a second time and frequency resource of the first set of time and frequency resources. In some examples, a resource separation value may be a numerical value, where a reserved resource shifted by the resource separation value may represent a resource supporting bidirectional communication. As depicted herein, the one or more parameters may include the first resource separation value and the second resource separation value. For instance, the UE 115-a may indicate an amount of separation (e.g., resource separation 240) {s₁, s₂, . . . sₘ} for resources {a₁, a₂, . . . aₘ} respectively to indicate the resources that are full-duplex capable. The UE 115-b (UE 2) and/or the UE 115-c (UE 3) may receive the control signal 225 and may determine that the one or more parameters include a first resource separation value and a second resource separation value. In some examples, the first resource separation value and the second resource separation value may be included in resource separation 240. The UE 2 and/or UE 3 may determine the second set of time and frequency resources based on applying the first resource separation value after a first time and frequency resource of the first set of time and frequency resources and the second resource separation value after a second time and frequency resource of the first set of time and frequency resources.

In some examples, the UE 115-a (UE 1) may transmit a resource separation value (e.g., threshold) sᵢ for every reservation resource at. That is, the UE 1 may determine the second set of time and frequency resources based at least in part on applying a threshold resource separation after each time and frequency resource of the first set of time and frequency resources. The one or more parameters included in the control signal 225 may include the threshold resource separation. For example, the resource separation 240 may be or otherwise include the threshold resource separation.

In some examples, the UE 115-a may provide the resource separation sᵢ for groups of resources c={a₁, a₂, . . . aₖ}, k≤m. The resource separation of s₁ may indicate that, a receiver UE (e.g., UE 115-b and/or UE 115-c) may communicate with the UE 115-a (UE 1) on subbands and/or physical resource blocks that are sᵢ subbands and/or physical resource blocks away from the reservation resources included in cᵢ. That is, the UE 115-b and/or the UE 115-c may determine the full-duplex capable resources (e.g., second set of resources) as {a₁+sᵢ, . . . aₖ+sᵢ}. Thus, the resource separation may indicate the parameters to be followed by the UE that intends to transmit to a full-duplex capable UE (e.g., UE 1).

According to one or more aspects, the UE 115-a may indicate at least one receive transmission configuration indicator state for one or more set of resources that are full-duplex capable. The receive transmission configuration indicator state may indicate the beam direction in which other UEs (e.g., UE 2 and/or UE 3) may communicate with the UE 1. For example, the UE 115-a (UE 1) may determine at least one receive transmission configuration indicator state for the second set of time and frequency resources supporting the full-duplex communication at the UE 115-a (UE 1). In some examples, the one or more parameters may include the at least one receive transmission configuration indicator state. In some examples, the receive transmission configuration indicator state may indicate the absolute beam direction in which the UE 115-b (UE 2) and/or the UE 115-c (UE 3) are to communicate with the UE 115-a (UE 1). For example, the UE 115-a (UE 1) may indicate that the UE 115-a is transmitting using transmit beams 250 at a first beam direction and over a first resource. The UE 115-a (UE 1) may further indicate that the UE 115-a (UE 1) is capable of receiving transmissions using receive beams 250 at a second beam direction. The UE 115-a may indicate the beam directions using transmission configuration indicator states. As depicted in the example of FIGS. 2 and 3, the UE 115-b (UE 2) may generate the resource pool 230 to include the reserved resources and the beam directions associated with the reserved resources. In some examples, the receive transmission configuration indicator state may indicate the relative beam direction with respect to the transmit beam direction at the UE 115-a. Thus, the at least one receive transmission configuration indicator state may indicate an absolute beam direction or a relative beam direction with respect to a current transmit beam direction. In one example, the UE 115-a may send a transmit beam 250 at a first beam direction to the UE 115-c (UE 3) and the UE 115-a (UE 1) may simultaneously receive transmissions using a receive beam 250 (to receive transmissions from the UE 115-b). Indication of the receive transmission configuration indicator state may ensure that the signal transmitted by any receive UE (e.g., UE 2 or UE 3) that intends to communicate with UE 1, arrives at UE 1 in a different direction than the one in which UE 1 is performing concurrent transmission. This ensures that the first UE (or UE 115-a or UE 1) is able to reliably perform full-duplex operation (i.e., concurrently perform transmission and reception from at least a second UE). As depicted herein, the second UE (e.g., UE 2 or UE 3) may be half-duplex UE or full-duplex UE.

According to one or more aspects, the UE 115-a (first UE or UE 1) may calculate a self-interference between a transmit chain and a receive chain at the UE 115-a. The UE 115-a may determine a reference signal received power threshold based on the calculated self-interference. In some examples, the one or more parameters may include the reference signal received power threshold. As depicted herein, the UE 115-a (e.g., full-duplex UE or UE capable of performing simultaneous transmission and reception) may indicate a reference signal received power threshold for a second UE intending to reliably communicate with the UE 115-a. That is, the reference signal received power threshold may indicate the signal level that UE 1 expects for reliable reception from a second UE (e.g., UE 2 or UE 3), so as to overcome the self-interference that occurs at the UE 1 (e.g., UE 115-a) between the transmit chain and the receive chain due to full-duplex communication.

In some aspects, the UE 115-a (first UE or UE 1) may determine a distance threshold based on a self-interference between a transmit chain and a receive chain at the UE 115-a. In some examples, the one or more parameters may include the distance threshold. In one or more aspects, the UE 115-a may provide the reference signal received power threshold as a distance threshold. For example, UEs (e.g., UE 2 and UE 3) located within the threshold distance from the UE 115-a may reliably communicate with the UE 115-a. Upon receiving the distance threshold included in the control signal 225, the UEs within the threshold distance may attempt to transmit on the reservation resources. In some examples, the UEs within the threshold distance may attempt to transmit on the reservation resources along the beam direction indicated by the receive transmission configuration indicator state.

According to one or more aspects, receiver UEs (e.g., UE 115-b or UE 2 and UE 115-c or UE 3) may receive the control signal 225 and may infer the resources reserved by the UE 115-a (UE 1) to be {a₁, a₂ . . . aₘ}. Of the reserved resources, the UE 2 and/or the UE 3 may determine resources which are full-duplex capable using the bit map indicated in the control signal 225. In one example, the UE 2 and/or the UE 3 may determine the full-duplex capable resources as d={d₁, d₂, . . . d_{f}}, f≤m. Of the full-duplex capable resources d, e UE 2 and/or the UE 3 may select resources that are sᵢ resources away from d (i.e., e={d₁+sᵢ, . . . d_{f}+sᵢ}) to incorporate the self-interference parameter indicated or otherwise imposed by the UE 115-a (e.g., transmitting UE). Additionally or alternatively, the receive transmission configuration indicator state for the UE 115-a may indicate the transmit beam which the receive UEs (UE 2 and/or UE 3) may use to be able to transmit to the UE 115-a. Of the receive UEs, the UE 115-b (UE 2) may already have a unicast connection with the UE 115-a and may be able to confirm the transmit beam direction (as indicated in the receive transmission configuration indicator state) with the UE 115-a for reliable full-duplex communication. Additionally or alternatively, the UE 115-c may not have a unicast communication with the UE 115-a and may use the advertised absolute or relative receive transmission configuration indicator state to determine the transmit beam direction to communicate with the UE 115-a. However, the presence of additional unicast link that the UE 115-b has with the UE 115-a may enable the UE 115-b to confirm or update the transmit beam direction based on the receive transmission configuration indicator state. Additionally or alternatively, the UE 115-b may initiate or reinitiate a radio resource control connection to determine change or updates in the receive transmission configuration indicator state.

FIG. 3 illustrates an example of a resource pool 300 that supports techniques for resource reservation in sidelink communications in accordance with one or more aspects of the present disclosure. In some examples, the resource pool 300 may implement aspects of wireless communications systems 100 or 200, or may be implemented by a UE 115 (or other wireless device), as described herein.

The resource pool 300 may be maintained by one or more UEs (e.g., UEs in a V2X system or another system that supports sidelink communications). For example, each UE may maintain a respective resource pool 300, which may indicate resources occupied, unoccupied, or reserved by other UEs (e.g., UE 115-a may maintain a respective resource pool for UE 115-b and UE 115-c as depicted in FIG. 2). The resource pool 300 may include multiple transmission time intervals (slots, mini-slots, symbols, etc.) and may span a portion of a frequency band (a channel, a carrier, a subcarrier, etc.), as shown. In the example of FIG. 3, the resource pool 300 may include transmission time intervals T1, T2 and T3. The resource pool 300 may include occupied resources R1, R2, R3 and R4, which may be reserved by other UEs in the system. The resource pool 300 may also include unoccupied resources, which may not be reserved by other UEs in the system.

The resource pool 300 may be generated at a UE based on control information (e.g., sidelink control information) or reservation information from other UEs. In the example of FIG. 2, the UE 115-a may transmit the control signal 225 to the UE 115-b. The UE 115-b may generate the resource pool 300 based on the control signal 225. For instance, a UE may receive one or more control messages from another UE, which may be decoded by the UE to determine the resources reserved by the other UE, one or more transmit directions of communication beams, or a combination thereof. Additionally or alternatively, the UE may receive a reservation indication from another UE, which may explicitly indicate the resources reserved by the other UE. Referring to the example of FIG. 2, upon receiving the control signal 225, the UE 115-b may determine that the UE 115-a has reserved resources R1, R2, R3 and R4. In some examples, the UE may receive the reservation indication via a control channel. As additional signals are received, the UE may update the resource pool 300 based on the reserved resources determined from the received signals.

In accordance with the techniques described herein, a UE capable of performing full-duplex communication (UE 115-a as depicted with reference to FIG. 2) may reserve resources R1, R2, R3, and R4. The full-duplex UE or transmitter UE (UE 115-a as depicted with reference to FIG. 2) may indicate in the control signaling, that resources R3 and R4 are suitable for performing full-duplex communications. A second UE (e.g., UE 115-b or UE 115-c as depicted with reference to FIG. 2) may construct the resource pool and may determine that the transmitter UE has reserved resources R1, R2, R3 and R4 for performing transmission and resources R3 and R4 among resources R1, R2, R3 and R4 support bi-directional communication. That is, a second UE can determine that the transmitter UE is capable of receiving transmissions over the resources R3 and R4 in parallel with transmitting over the resources R3 and R4.

Additionally or alternatively, a transmitter UE may determine a beam direction associated with a transmission. For example, a transmitter UE may send beamformed transmission over the reserved resources R1, R2, R3, and R4. As depicted in the example of FIG. 3, the transmitter UE may determine a transmit beam direction 305 and a receive beam direction 310 for the resource R3. That is, for resource R3, the transmitter UE may perform transmissions by sending a transmit beam along the transmit beam direction 305. The transmitter UE may indicate that a transmitter UE may also receive transmissions over the resource R3 using a receive beam along the receive beam direction 310. Referring to the example of FIG. 2, the UE 115-b, upon generating the resource pool 230, may determine that the UE 115-a is capable of receiving transmissions over resource R3 using beamformed communications along the receive beam direction 310. In some examples, the UE 115-b may send a transmission to the UE 115-a along the receive beam direction 310 over the resource R3.

Additionally or alternatively, the transmitter UE may determine a transmit beam direction 315 and a receive beam direction 320 for the resource R4. In some examples, based on this, the transmitter UE may advertise the receive directions that it can receive on resources R3 and R4. For example, the transmitter UE may indicate one or more of the transmit beam direction 305, the receive beam direction 310 for resource R3 and the transmit beam direction 315 and the receive beam direction 320 for resource R4. In some examples, the transmitter UE may use at least one receive transmission configuration indicator state to indicate one or more of the transmit beam direction 305, the receive beam direction 310 for resource R3 and the transmit beam direction 315 and the receive beam direction 320 for resource R4. A receiver UE may receive a control signal and may determine the resources R3 and R4 for performing full-duplex communications. For resources R3 and R4, the receiver UE may then determine a beam direction associated with a transmission. As depicted in the example of FIG. 2, the UE 115-b, upon generating the resource pool 230, may determine that the UE 115-a is capable of receiving transmissions over the resource R3 using beamformed communications along the receive beam direction 310 and receiving transmissions over the resource R4 using beamformed communications along the receive beam direction 320. The UE 115-b may then send beamformed transmissions to the UE 115-a along the receive beam direction 310 using the resource R3 or along the receive beam direction 320 using the resource R4, or both.

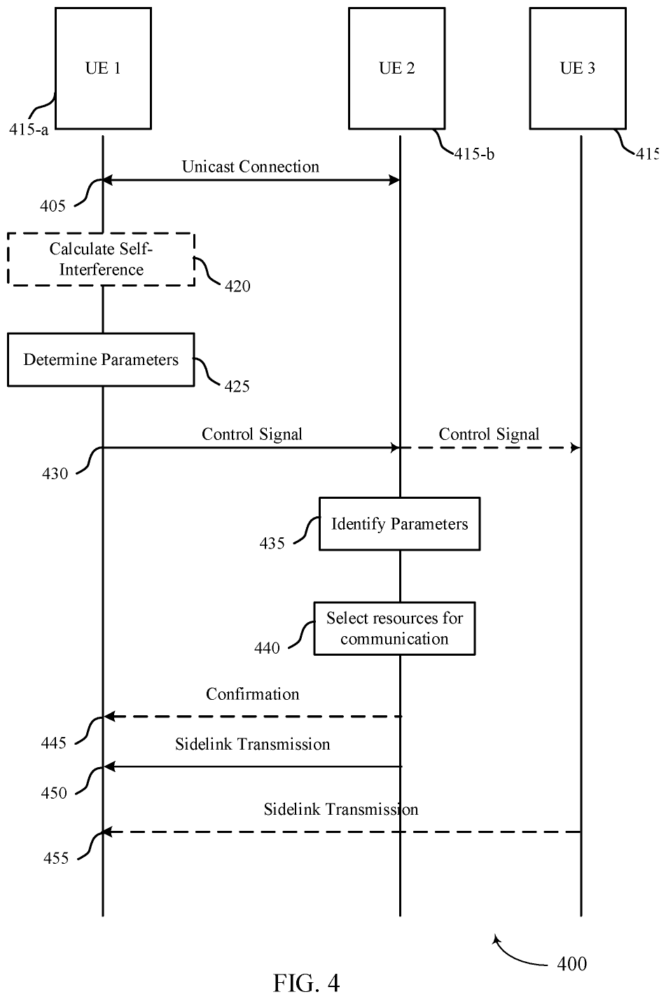

FIG. 4 illustrates an example of a process flow 400 that supports techniques for resource reservation in sidelink communications in accordance with one or more aspects of the present disclosure. In some examples, the process flow 400 may implement aspects of wireless communications system 100 and the wireless communications system 200 described with reference to FIGS. 1 and 2, respectively. For example, the process flow 400 may be based on one or more rules for inter-UE coordination in sidelink communication. The process flow 400 may be implemented by the UE 415-a (UE 1), the UE 415-b (UE 2) and the UE 415-c (UE 3) for reduced power consumption, and may promote low latency and low interference for wireless communications supporting high priority channels, among other benefits. The UE 415-a, the UE 415-b and the UE 415-c may be examples of a UE 115, as described with reference to FIGS. 1 and 2.

In the following description of the process flow 400, the operations between the UE 415-a (UE 1), the UE 415-b (UE 2) and the UE 415-c (UE 3) may be transmitted in a different order than the example order shown, or the operations performed by the UE 415-a (UE 1), the UE 415-b (UE 2) and the UE 415-c (UE 3) may be performed in different orders or at different times. Some operations may also be omitted from the process flow 400, and other operations may be added to the process flow 400.

At 405, the UE 415-a (UE 1 or the first UE) and the UE 415-b may have an unicast connection. At 420, the UE 415-a (UE 1 or the first UE) may calculate a self-interference between a transmit chain and a receive chain at the UE 415-a. At 410, the UE 415-a (UE 1) may determine one or more parameters. For instance, the UE 415-a (UE 1) may determine one or more parameters to be used by a second UE (e.g., UE 415-b or UE 2) to identify time and frequency resources for performing a full-duplex communication with the UE 415-a.

In some examples, the UE 415-a (UE 1 or the first UE) may determine that the UE 415-a is capable of performing full-duplex communications. The UE 415-a (UE 1) may be a subband full-duplex UE or a single frequency full-duplex UE. That is, the UE 415-a may determine that a first set of time and frequency resources is associated with a sidelink transmission. In some examples, the UE 415-a may determine the one or more parameters to be used by the UE 415-b to identify a second set of time and frequency resources for performing a full-duplex communication with the UE 415-a. As depicted herein, the second set of time and frequency resources may include a subset of the first set of time and frequency resources.

According to one or more aspects, the UE 415-a (UE 1) may determine a bitmap including a set of bits indicating the second set of time and frequency resources supporting the full-duplex communication. In some aspects, the one or more parameters may include the second set of time and frequency resources supporting the full-duplex communication. Additionally or alternatively, the UE 415-a (UE 1) may determine the second set of time and frequency resources based on applying a first resource separation value after a first time and frequency resource of the first set of time and frequency resources and a second resource separation value after a second time and frequency resource of the first set of time and frequency resources. In some examples, the one or more parameters may include the first resource separation value and the second resource separation value.

In some examples, the UE 415-a may determine the second set of time and frequency resources based on applying a threshold resource separation after each time and frequency resource of the first set of time and frequency resources. In some examples, the one or more parameters may include the threshold resource separation. In some aspects, the threshold resource separation may include a threshold number of physical resource blocks or a threshold number of subbands or both.

In some examples, the UE 415-a (UE 1) may determine at least one receive transmission configuration indicator state for the second set of time and frequency resources supporting the full-duplex communication at the UE 415-a (UE 1). In some examples, the one or more parameters may include the at least one receive transmission configuration indicator state. In some instances, the at least one receive transmission configuration indicator state may indicate an absolute beam direction or a relative beam direction with respect to a current transmit beam direction.

Upon determining the self-interference, the UE 415-a (UE 1) may determine a reference signal received power threshold based on the calculated self-interference. In some examples, the one or more parameters may include the reference signal received power threshold. In some examples, the UE 415-a (UE 1) may determine a distance threshold based on a self-interference between a transmit chain and a receive chain at the UE 415-a (UE 1). In some examples, the one or more parameters may include the distance threshold.

At 430, the UE 415-a (UE 1) may transmit control signaling to reserve the first set of time and frequency resources for a sidelink transmission. The control signaling may indicate the one or more parameters to be used by the UE 415-b (UE 2 or second UE) to identify the second set of time and frequency resources for performing the full-duplex communication with the UE 415-a (UE 1). The UE 415-a may also optionally transmit the control signaling to the UE 415-c.

At 435, the UE 415-b may receive the control signal from the UE 415-a and the UE 415-b may identify the one or more parameters to be used by the UE 415-b to identify the second set of time and frequency resources associated with a full-duplex communication. At 440, the UE 415-b may select resources for performing full-duplex communications with the UE 415-a. For instance, the UE 415-b may determine that the one or more parameters include a threshold resource separation. The UE 415-b may then determine the second set of time and frequency resources based on applying the threshold resource separation after each time and frequency resource of the first set of time and frequency resources.

Additionally or alternatively, upon receiving the control signal, the UE 415-b may determine that the one or more parameters include a first resource separation value and a second resource separation value. In some examples, the UE 415-b may then determine the second set of time and frequency resources based on applying the first resource separation value after a first time and frequency resource of the first set of time and frequency resources and the second resource separation value after a second time and frequency resource of the first set of time and frequency resources.

At 445, the UE 415-b (UE 2) may transmit a confirmation of a transmit beam direction (as indicated in the receive transmission configuration indicator state included in the control signal transmitted at 430) to the UE 415-a. At 450, the UE 415-b (or UE 2) may communicate with the UE 415-a based on the indicated one or more parameters associated with the second set of time and frequency resources. For example, the UE 415-b may transmit sidelink transmission to the UE 415-a using the second set of time and frequency resources. The UE 415-a may simultaneously transmit and receiving transmissions during the second set of time and frequency resources. At 455, the UE 415-c (or UE 3) may optionally communicate with the UE 415-a based on the indicated one or more parameters associated with the second set of time and frequency resources (e.g., beam direction advertised using receive transmission configuration indicator state).

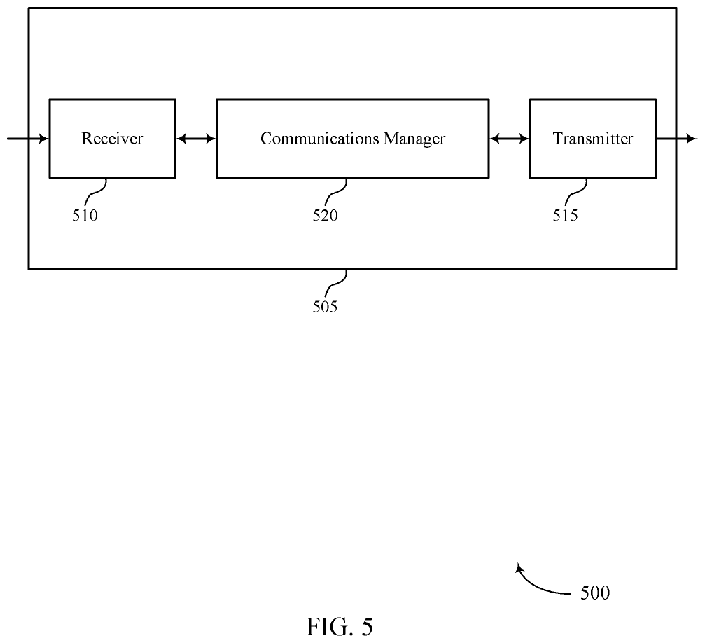

FIG. 5 shows a block diagram 500 of a device 505 that supports techniques for resource reservation in sidelink communications in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for resource reservation in sidelink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for resource reservation in sidelink communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for resource reservation in sidelink communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first UE in accordance with examples as disclosed herein. For example, the communications manager 520 may be configured as or otherwise support a means for transmitting control signaling to reserve a first set of time and frequency resources for a sidelink transmission, the control signaling indicating one or more parameters to be used by a second UE to identify a second set of time and frequency resources for performing a full-duplex communication with the first UE. The communications manager 520 may be configured as or otherwise support a means for communicating with the second UE based on the reserved first set of time and frequency resources and the indicated one or more parameters associated with the second set of time and frequency resources.

Additionally or alternatively, the communications manager 520 may support wireless communication in accordance with examples as disclosed herein. For example, the communications manager 520 may be configured as or otherwise support a means for receiving, from a UE, control signaling to reserve a first set of time and frequency resources for a sidelink transmission, the control signaling indicating one or more parameters to be used to identify a second set of time and frequency resources for performing a full-duplex communication with the UE. The communications manager 520 may be configured as or otherwise support a means for communicating with the UE based on the indicated one or more parameters associated with the second set of time and frequency resources.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for enhanced processing, enhanced power savings, and more efficient utilization of communication resources.

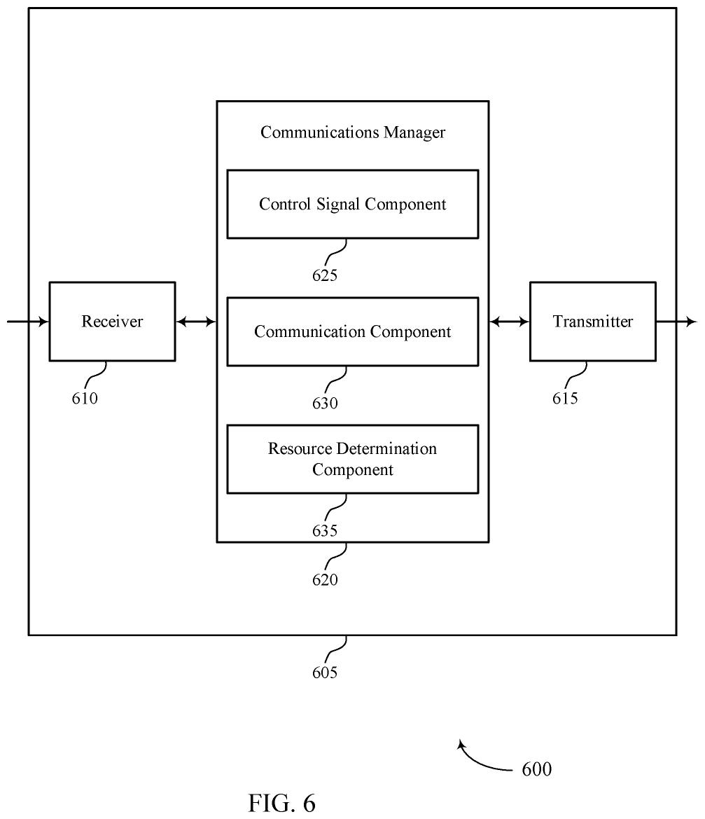

FIG. 6 shows a block diagram 600 of a device 605 that supports techniques for resource reservation in sidelink communications in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for resource reservation in sidelink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for resource reservation in sidelink communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for resource reservation in sidelink communications as described herein. For example, the communications manager 620 may include a control signal component 625, a communication component 630, a resource determination component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. The control signal component 625 may be configured as or otherwise support a means for transmitting control signaling to reserve a first set of time and frequency resources for a sidelink transmission, the control signaling indicating one or more parameters to be used by a second UE to identify a second set of time and frequency resources for performing a full-duplex communication with the first UE. The communication component 630 may be configured as or otherwise support a means for communicating with the second UE based on the reserved first set of time and frequency resources and the indicated one or more parameters associated with the second set of time and frequency resources.

Additionally or alternatively, the communications manager 620 may support wireless communication in accordance with examples as disclosed herein. The resource determination component 635 may be configured as or otherwise support a means for receiving, from a UE, control signaling to reserve a first set of time and frequency resources for a sidelink transmission, the control signaling indicating one or more parameters to be used to identify a second set of time and frequency resources for performing a full-duplex communication with the UE. The communication component 630 may be configured as or otherwise support a means for communicating with the UE based on the indicated one or more parameters associated with the second set of time and frequency resources.

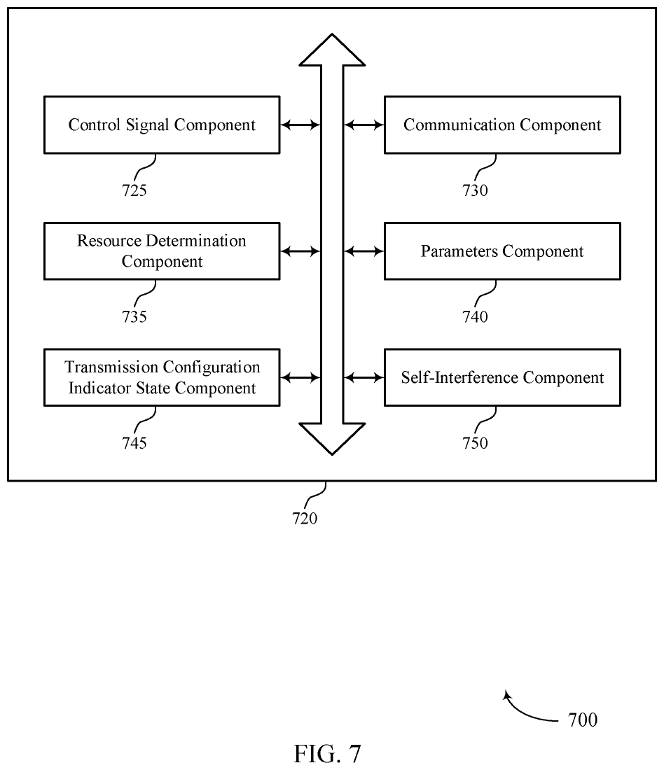

FIG. 7 shows a block diagram 700 of a communications manager 720 that supports techniques for resource reservation in sidelink communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for resource reservation in sidelink communications as described herein. For example, the communications manager 720 may include a control signal component 725, a communication component 730, a resource determination component 735, a parameters component 740, a transmission configuration indicator state component 745, a self-interference component 750, or any combination thereof. Each of these components may communicate, directly or indirectly, with one another (e.g., via one or more buses).

The communications manager 720 may support wireless communication at a first UE in accordance with examples as disclosed herein. The control signal component 725 may be configured as or otherwise support a means for transmitting control signaling to reserve a first set of time and frequency resources for a sidelink transmission, the control signaling indicating one or more parameters to be used by a second UE to identify a second set of time and frequency resources for performing a full-duplex communication with the first UE. The communication component 730 may be configured as or otherwise support a means for communicating with the second UE based on the reserved first set of time and frequency resources and the indicated one or more parameters associated with the second set of time and frequency resources.

In some examples, the parameters component 740 may be configured as or otherwise support a means for determining a bitmap including a set of bits indicating the second set of time and frequency resources supporting the full-duplex communication, where the one or more parameters include the second set of time and frequency resources supporting the full-duplex communication.

In some examples, the parameters component 740 may be configured as or otherwise support a means for determining the second set of time and frequency resources based on applying a first resource separation value after a first time and frequency resource of the first set of time and frequency resources and a second resource separation value after a second time and frequency resource of the first set of time and frequency resources, where the one or more parameters include the first resource separation value and the second resource separation value.

In some examples, the parameters component 740 may be configured as or otherwise support a means for determining the second set of time and frequency resources based on applying a threshold resource separation after each time and frequency resource of the first set of time and frequency resources, where the one or more parameters include the threshold resource separation. In some examples, the threshold resource separation includes a threshold number of physical resource blocks or a threshold number of subbands or both.

In some examples, the transmission configuration indicator state component 745 may be configured as or otherwise support a means for determining at least one receive transmission configuration indicator state for the second set of time and frequency resources supporting the full-duplex communication at the first UE, where the one or more parameters include the at least one receive transmission configuration indicator state. In some examples, the at least one receive transmission configuration indicator state indicates an absolute beam direction or a relative beam direction with respect to a current transmit beam direction.

In some examples, the self-interference component 750 may be configured as or otherwise support a means for calculating a self-interference between a transmit chain and a receive chain at the first UE. In some examples, the self-interference component 750 may be configured as or otherwise support a means for determining a reference signal received power threshold based on the calculated self-interference, where the one or more parameters include the reference signal received power threshold. In some examples, the self-interference component 750 may be configured as or otherwise support a means for determining a distance threshold based on a self-interference between a transmit chain and a receive chain at the first UE, where the one or more parameters include the distance threshold.

In some examples, the second set of time and frequency resources includes a subset of the first set of time and frequency resources. In some examples, the first UE includes a subband full-duplex UE or a single frequency full-duplex UE.

Additionally or alternatively, the communications manager 720 may support wireless communication in accordance with examples as disclosed herein. The resource determination component 735 may be configured as or otherwise support a means for receiving, from a UE, control signaling to reserve a first set of time and frequency resources for a sidelink transmission, the control signaling indicating one or more parameters to be used to identify a second set of time and frequency resources for performing a full-duplex communication with the UE. In some examples, the communication component 730 may be configured as or otherwise support a means for communicating with the UE based on the indicated one or more parameters associated with the second set of time and frequency resources.

In some examples, the parameters component 740 may be configured as or otherwise support a means for determining a bitmap including a set of bits indicating the second set of time and frequency resources supporting the full-duplex communication, where the one or more parameters include the set of bits indicating the second set of time and frequency resources supporting the full-duplex communication.

In some examples, the parameters component 740 may be configured as or otherwise support a means for determining that the one or more parameters include a first resource separation value and a second resource separation value. In some examples, the resource determination component 735 may be configured as or otherwise support a means for determining the second set of time and frequency resources based on applying the first resource separation value after a first time and frequency resource of the first set of time and frequency resources and the second resource separation value after a second time and frequency resource of the first set of time and frequency resources.

In some examples, the parameters component 740 may be configured as or otherwise support a means for determining that the one or more parameters include a threshold resource separation. In some examples, the resource determination component 735 may be configured as or otherwise support a means for determining the second set of time and frequency resources based on applying the threshold resource separation after each time and frequency resource of the first set of time and frequency resources. In some examples, the threshold resource separation includes a threshold number of physical resource blocks or a threshold number of subbands or both.

In some examples, the transmission configuration indicator state component 745 may be configured as or otherwise support a means for determining at least one receive transmission configuration indicator state for the second set of time and frequency resources supporting the full-duplex communication at the UE, where the one or more parameters include the at least one receive transmission configuration indicator state. In some examples, the at least one receive transmission configuration indicator state indicates an absolute beam direction or a relative beam direction with respect to a current transmit beam direction.

In some examples, the parameters component 740 may be configured as or otherwise support a means for receiving, from the UE, a reference signal received power threshold. In some examples, the resource determination component 735 may be configured as or otherwise support a means for determining the second set of time and frequency resources based on the reference signal received power threshold. In some examples, the parameters component 740 may be configured as or otherwise support a means for receiving, from the UE, a distance threshold. In some examples, the resource determination component 735 may be configured as or otherwise support a means for determining the second set of time and frequency resources based on the distance threshold.

In some examples, the second set of time and frequency resources includes a subset of the first set of time and frequency resources. In some examples, the UE includes a subband full-duplex UE or a single frequency full-duplex UE.

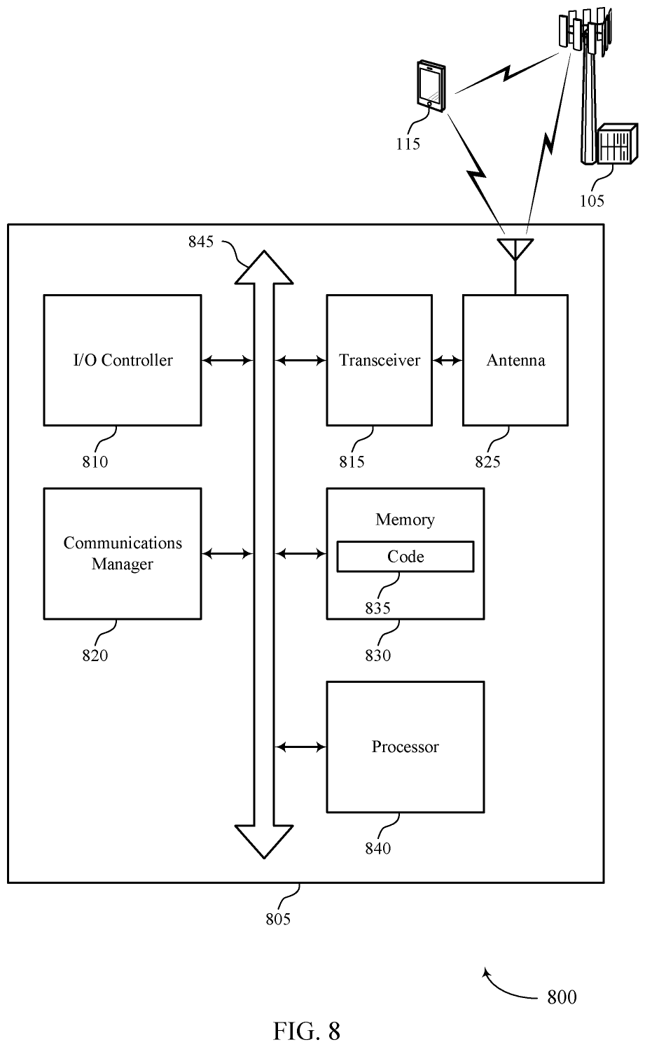

FIG. 8 shows a diagram of a system 800 including a device 805 that supports techniques for resource reservation in sidelink communications in accordance with one or more aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for resource reservation in sidelink communications). For example, the device 805 or a component of the device 805 may include a processor 840 and memory 830 coupled to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for transmitting control signaling to reserve a first set of time and frequency resources for a sidelink transmission, the control signaling indicating one or more parameters to be used by a second UE to identify a second set of time and frequency resources for performing a full-duplex communication with the first UE. The communications manager 820 may be configured as or otherwise support a means for communicating with the second UE based on the reserved first set of time and frequency resources and the indicated one or more parameters associated with the second set of time and frequency resources.

Additionally or alternatively, the communications manager 820 may support wireless communication in accordance with examples as disclosed herein. For example, the communications manager 820 may be configured as or otherwise support a means for receiving, from a UE, control signaling to reserve a first set of time and frequency resources for a sidelink transmission, the control signaling indicating one or more parameters to be used to identify a second set of time and frequency resources for performing a full-duplex communication with the UE. The communications manager 820 may be configured as or otherwise support a means for communicating with the UE based on the indicated one or more parameters associated with the second set of time and frequency resources.

By including or configuring the communications manager 820 in accordance with examples as described herein, the device 805 may support techniques for improved communication reliability, improved user experience related to reduced processing, efficient utilization of power, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for resource reservation in sidelink communications as described herein, or the processor 840 and the memory 830 may be otherwise configured to perform or support such operations.

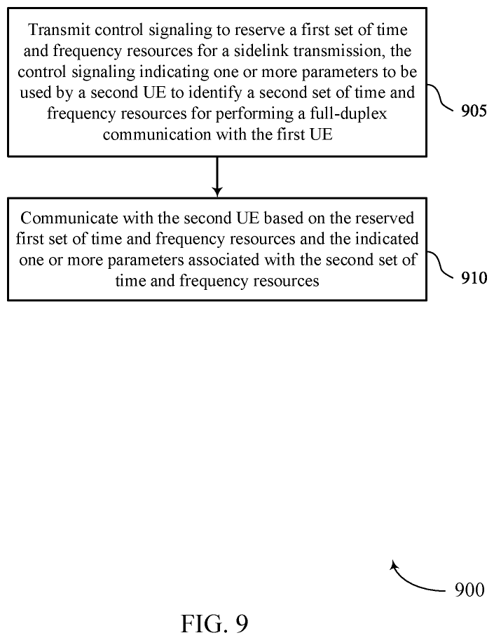

FIG. 9 shows a flowchart illustrating a method 900 that supports techniques for resource reservation in sidelink communications in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include transmitting control signaling to reserve a first set of time and frequency resources for a sidelink transmission, the control signaling indicating one or more parameters to be used by a second UE to identify a second set of time and frequency resources for performing a full-duplex communication with the first UE. The operations of 905 may be performed in accordance with examples as disclosed herein. In some examples, aspects of the operations of 905 may be performed by a control signal component 725 as described with reference to FIG. 7.

At 910, the method may include communicating with the second UE based on the reserved first set of time and frequency resources and the indicated one or more parameters associated with the second set of time and frequency resources. The operations of 910 may be performed in accordance with examples as disclosed herein. In some examples, aspects of the operations of 910 may be performed by a communication component 730 as described with reference to FIG. 7.

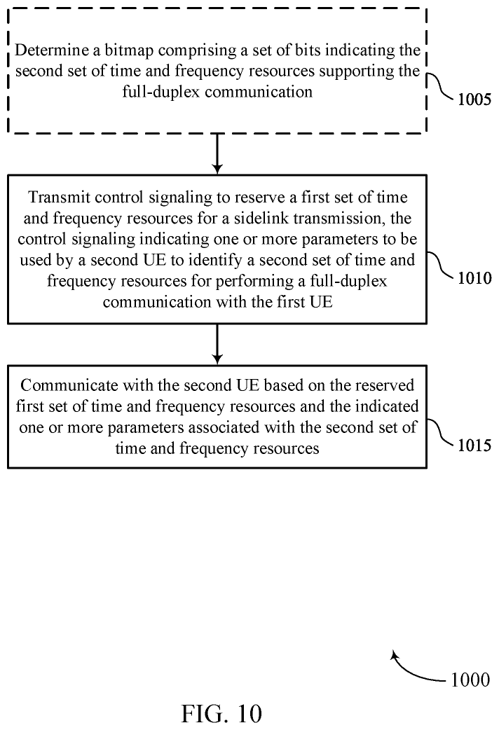

FIG. 10 shows a flowchart illustrating a method 1000 that supports techniques for resource reservation in sidelink communications in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may optionally include determining a bitmap including a set of bits indicating the second set of time and frequency resources supporting the full-duplex communication. The operations of 1005 may be performed in accordance with examples as disclosed herein. In some examples, aspects of the operations of 1005 may be performed by a parameters component 740 as described with reference to FIG. 7.

At 1010, the method may include transmitting control signaling to reserve a first set of time and frequency resources for a sidelink transmission, the control signaling indicating one or more parameters to be used by a second UE to identify a second set of time and frequency resources for performing a full-duplex communication with the first UE. In some examples, the one or more parameters include the second set of time and frequency resources supporting the full-duplex communication. The operations of 1010 may be performed in accordance with examples as disclosed herein. In some examples, aspects of the operations of 1010 may be performed by a control signal component 725 as described with reference to FIG. 7.

At 1015, the method may include communicating with the second UE based on the reserved first set of time and frequency resources and the indicated one or more parameters associated with the second set of time and frequency resources. The operations of 1015 may be performed in accordance with examples as disclosed herein. In some examples, aspects of the operations of 1015 may be performed by a communication component 730 as described with reference to FIG. 7.

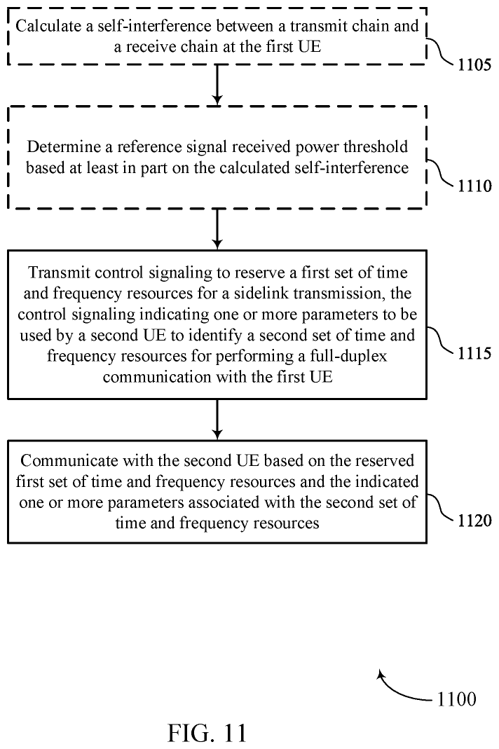

FIG. 11 shows a flowchart illustrating a method 1100 that supports techniques for resource reservation in sidelink communications in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may optionally include calculating a self-interference between a transmit chain and a receive chain at the first UE. The operations of 1105 may be performed in accordance with examples as disclosed herein. In some examples, aspects of the operations of 1105 may be performed by a self-interference component 750 as described with reference to FIG. 7.

At 1110, the method may optionally include determining a reference signal received power threshold based on the calculated self-interference. The operations of 1110 may be performed in accordance with examples as disclosed herein. In some examples, aspects of the operations of 1110 may be performed by a self-interference component 750 as described with reference to FIG. 7.

At 1115, the method may include transmitting control signaling to reserve a first set of time and frequency resources for a sidelink transmission, the control signaling indicating one or more parameters to be used by a second UE to identify a second set of time and frequency resources for performing a full-duplex communication with the first UE. In some examples, the one or more parameters include the reference signal received power threshold. The operations of 1115 may be performed in accordance with examples as disclosed herein. In some examples, aspects of the operations of 1115 may be performed by a control signal component 725 as described with reference to FIG. 7.

At 1120, the method may include communicating with the second UE based on the reserved first set of time and frequency resources and the indicated one or more parameters associated with the second set of time and frequency resources. The operations of 1120 may be performed in accordance with examples as disclosed herein. In some examples, aspects of the operations of 1120 may be performed by a communication component 730 as described with reference to FIG. 7.

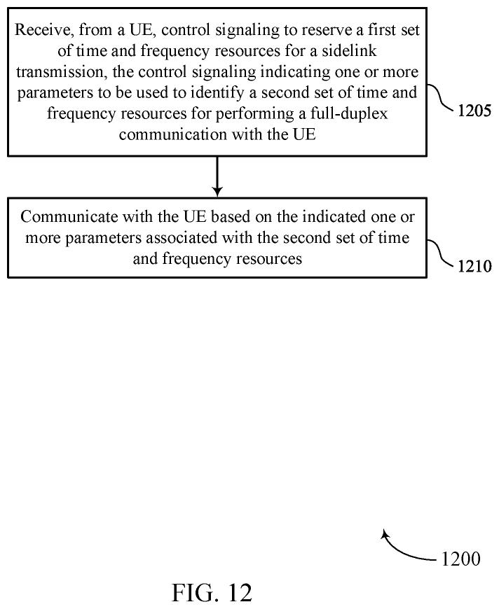

FIG. 12 shows a flowchart illustrating a method 1200 that supports techniques for resource reservation in sidelink communications in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include receiving, from a UE, control signaling to reserve a first set of time and frequency resources for a sidelink transmission, the control signaling indicating one or more parameters to be used to identify a second set of time and frequency resources for performing a full-duplex communication with the UE. The operations of 1205 may be performed in accordance with examples as disclosed herein. In some examples, aspects of the operations of 1205 may be performed by a resource determination component 735 as described with reference to FIG. 7.

At 1210, the method may include communicating with the UE based on the indicated one or more parameters associated with the second set of time and frequency resources. The operations of 1210 may be performed in accordance with examples as disclosed herein. In some examples, aspects of the operations of 1210 may be performed by a communication component 730 as described with reference to FIG. 7.

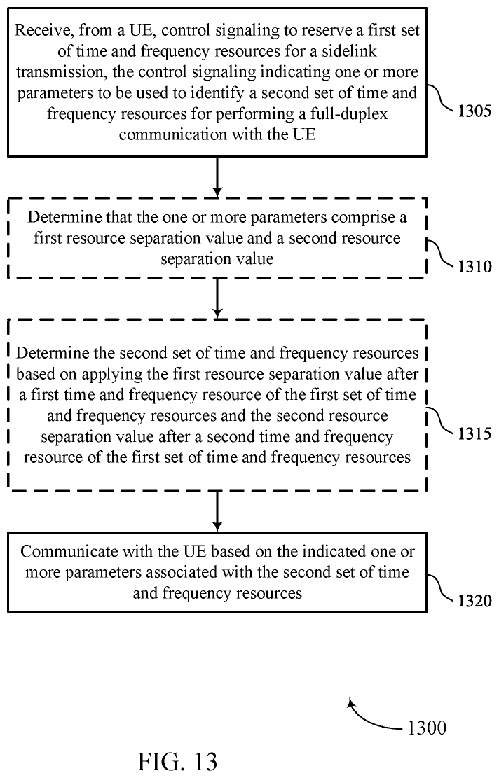

FIG. 13 shows a flowchart illustrating a method 1300 that supports techniques for resource reservation in sidelink communications in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a UE, control signaling to reserve a first set of time and frequency resources for a sidelink transmission, the control signaling indicating one or more parameters to be used to identify a second set of time and frequency resources for performing a full-duplex communication with the UE. The operations of 1305 may be performed in accordance with examples as disclosed herein. In some examples, aspects of the operations of 1305 may be performed by a resource determination component 735 as described with reference to FIG. 7.

At 1310, the method may optionally include determining that the one or more parameters include a first resource separation value and a second resource separation value. The operations of 1310 may be performed in accordance with examples as disclosed herein. In some examples, aspects of the operations of 1310 may be performed by a parameters component 740 as described with reference to FIG. 7.

At 1315, the method may optionally include determining the second set of time and frequency resources based on applying the first resource separation value after a first time and frequency resource of the first set of time and frequency resources and the second resource separation value after a second time and frequency resource of the first set of time and frequency resources. The operations of 1315 may be performed in accordance with examples as disclosed herein. In some examples, aspects of the operations of 1315 may be performed by a resource determination component 735 as described with reference to FIG. 7.

At 1320, the method may include communicating with the UE based on the indicated one or more parameters associated with the second set of time and frequency resources. The operations of 1320 may be performed in accordance with examples as disclosed herein. In some examples, aspects of the operations of 1320 may be performed by a communication component 730 as described with reference to FIG. 7.

The following provides an overview of aspects of the present disclosure:

Aspect 1: A method for wireless communication at a first UE, comprising: transmitting control signaling to reserve a first set of time and frequency resources for a sidelink transmission, the control signaling indicating one or more parameters to be used by a second UE to identify a second set of time and frequency resources for performing a full-duplex communication with the first UE; and communicating with a second UE based at least in part on the reserved first set of time and frequency resources and the indicated one or more parameters associated with the second set of time and frequency resources.

Aspect 2: The method of aspect 1, further comprising: determining a bitmap comprising a set of bits indicating the second set of time and frequency resources supporting the full-duplex communication, wherein the one or more parameters comprise the second set of time and frequency resources supporting the full-duplex communication.

Aspect 3: The method of any of aspects 1 through 2, further comprising: determining the second set of time and frequency resources based at least in part on applying a first resource separation value after a first time and frequency resource of the first set of time and frequency resources and a second resource separation value after a second time and frequency resource of the first set of time and frequency resources, wherein the one or more parameters comprise the first resource separation value and the second resource separation value.

Aspect 4: The method of any of aspects 1 through 3, further comprising: determining the second set of time and frequency resources based at least in part on applying a threshold resource separation after each time and frequency resource of the first set of time and frequency resources, wherein the one or more parameters comprise the threshold resource separation.

Aspect 5: The method of aspect 4, wherein the threshold resource separation comprises a threshold number of physical resource blocks or a threshold number of subbands or both.

Aspect 6: The method of any of aspects 1 through 5, further comprising: determining at least one receive transmission configuration indicator state for the second set of time and frequency resources supporting the full-duplex communication at the first UE, wherein the one or more parameters comprise the at least one receive transmission configuration indicator state.

Aspect 7: The method of aspect 6, wherein the at least one receive transmission configuration indicator state indicates an absolute beam direction or a relative beam direction with respect to a current transmit beam direction.

Aspect 8: The method of any of aspects 1 through 7, further comprising: calculating a self-interference between a transmit chain and a receive chain at the first UE; and determining a reference signal received power threshold based at least in part on the calculated self-interference, wherein the one or more parameters comprise the reference signal received power threshold.

Aspect 9: The method of any of aspects 1 through 8, further comprising: determining a distance threshold based at least in part on a self-interference between a transmit chain and a receive chain at the first UE, wherein the one or more parameters comprise the distance threshold.

Aspect 10: The method of any of aspects 1 through 9, wherein the second set of time and frequency resources comprises a subset of the first set of time and frequency resources.

Aspect 11: The method of any of aspects 1 through 10, wherein the first UE comprises a subband full duplex UE or a single frequency full duplex UE.

Aspect 12: A method for wireless communication, comprising: receiving, from a UE, control signaling to reserve a first set of time and frequency resources for a sidelink transmission, the control signaling indicating one or more parameters to be used to identify a second set of time and frequency resources for performing a full-duplex communication with the UE; and communicating with the UE based at least in part on the indicated one or more parameters associated with the second set of time and frequency resources.

Aspect 13: The method of aspect 12, further comprising: determining a bitmap comprising a set of bits indicating the second set of time and frequency resources supporting the full-duplex communication, wherein the one or more parameters comprise the set of bits indicating the second set of time and frequency resources supporting the full-duplex communication.

Aspect 14: The method of any of aspects 12 through 13, further comprising: determining that the one or more parameters comprise a first resource separation value and a second resource separation value; and determining the second set of time and frequency resources based at least in part on applying the first resource separation value after a first time and frequency resource of the first set of time and frequency resources and the second resource separation value after a second time and frequency resource of the first set of time and frequency resources.

Aspect 15: The method of any of aspects 12 through 14, further comprising: determining that the one or more parameters comprise a threshold resource separation; and determining the second set of time and frequency resources based at least in part on applying the threshold resource separation after each time and frequency resource of the first set of time and frequency resources.

Aspect 16: The method of aspect 15, wherein the threshold resource separation comprises a threshold number of physical resource blocks or a threshold number of subbands or both.

Aspect 17: The method of any of aspects 12 through 16, further comprising: determining at least one receive transmission configuration indicator state for the second set of time and frequency resources supporting the full-duplex communication at the UE, wherein the one or more parameters comprise the at least one receive transmission configuration indicator state.

Aspect 18: The method of aspect 17, wherein the at least one receive transmission configuration indicator state indicates an absolute beam direction or a relative beam direction with respect to a current transmit beam direction.

Aspect 19: The method of any of aspects 12 through 18, further comprising: receiving, from the UE, a reference signal received power threshold; and determining the second set of time and frequency resources based at least in part on the reference signal received power threshold.

Aspect 20: The method of any of aspects 12 through 19, further comprising: receiving, from the UE, a distance threshold; and determining the second set of time and frequency resources based at least in part on the distance threshold.

Aspect 21: The method of any of aspects 12 through 20, wherein the second set of time and frequency resources comprises a subset of the first set of time and frequency resources.

Aspect 22: The method of any of aspects 12 through 21, wherein the UE comprises a subband full duplex UE or a single frequency full duplex UE.

Aspect 23: An apparatus for wireless communication at a first UE, comprising a processor; memory coupled with the processor; and instructions stored in the memory and executable by the processor to cause the apparatus to perform a method of any of aspects 1 through 11.

Aspect 24: An apparatus for wireless communication at a first UE, comprising at least one means for performing a method of any of aspects 1 through 11.

Aspect 25: A non-transitory computer-readable medium storing code for wireless communication at a first UE, the code comprising instructions executable by a processor to perform a method of any of aspects 1 through 11.

Aspect 26: An apparatus for wireless communication, comprising a processor; memory coupled with the processor; and instructions stored in the memory and executable by the processor to cause the apparatus to perform a method of any of aspects 12 through 22.

Aspect 27: An apparatus for wireless communication, comprising at least one means for performing a method of any of aspects 12 through 22.

Aspect 28: A non-transitory computer-readable medium storing code for wireless communication, the code comprising instructions executable by a processor to perform a method of any of aspects 12 through 22.

It should be noted that the methods described herein describe possible implementations, and that the operations may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example operation that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
transmitting control signaling to reserve a first set of time and frequency resources for a sidelink transmission, the control signaling indicating one or more parameters to be used by a second UE to identify a second set of time and frequency resources for performing a full-duplex communication with the first UE; and
communicating with the second UE based at least in part on the reserved first set of time and frequency resources and the indicated one or more parameters associated with the second set of time and frequency resources.

2. The method of claim 1, further comprising:
determining a bitmap comprising a set of bits indicating the second set of time and frequency resources supporting the full-duplex communication, wherein the one or more parameters comprise the second set of time and frequency resources supporting the full-duplex communication.

3. The method of claim 1, further comprising:
determining the second set of time and frequency resources based at least in part on applying a first resource separation value after a first time and frequency resource of the first set of time and frequency resources and a second resource separation value after a second time and frequency resource of the first set of time and frequency resources, wherein the one or more parameters comprise the first resource separation value and the second resource separation value.

4. The method of claim 1, further comprising:
determining the second set of time and frequency resources based at least in part on applying a threshold resource separation after each time and frequency resource of the first set of time and frequency resources, wherein the one or more parameters comprise the threshold resource separation.

5. The method of claim 4, wherein the threshold resource separation comprises a threshold number of physical resource blocks or a threshold number of subbands or both.

6. The method of claim 1, further comprising:
determining at least one receive transmission configuration indicator state for the second set of time and frequency resources supporting the full-duplex communication at the first UE, wherein the one or more parameters comprise the at least one receive transmission configuration indicator state.

7. The method of claim 6, wherein the at least one receive transmission configuration indicator state indicates an absolute beam direction or a relative beam direction with respect to a current transmit beam direction.

8. The method of claim 1, further comprising:
calculating a self-interference between a transmit chain and a receive chain at the first UE; and
determining a reference signal received power threshold based at least in part on the calculated self-interference, wherein the one or more parameters comprise the reference signal received power threshold.

9. The method of claim 1, further comprising:
determining a distance threshold based at least in part on a self-interference between a transmit chain and a receive chain at the first UE, wherein the one or more parameters comprise the distance threshold.

10. The method of claim 1, wherein the second set of time and frequency resources comprises a subset of the first set of time and frequency resources.

11. The method of claim 1, wherein the first UE comprises a subband full-duplex UE or a single frequency full-duplex UE.

12. A method for wireless communication, comprising:
receiving, from a UE, control signaling to reserve a first set of time and frequency resources for a sidelink transmission, the control signaling indicating one or more parameters to be used to identify a second set of time and frequency resources for performing a full-duplex communication with the UE; and
communicating with the UE based at least in part on the indicated one or more parameters associated with the second set of time and frequency resources.

13. The method of claim 12, further comprising:
determining a bitmap comprising a set of bits indicating the second set of time and frequency resources supporting the full-duplex communication, wherein the one or more parameters comprise the set of bits indicating the second set of time and frequency resources supporting the full-duplex communication.

14. The method of claim 12, further comprising:
determining that the one or more parameters comprise a first resource separation value and a second resource separation value; and
determining the second set of time and frequency resources based at least in part on applying the first resource separation value after a first time and frequency resource of the first set of time and frequency resources and the second resource separation value after a second time and frequency resource of the first set of time and frequency resources.

15. The method of claim 12, further comprising:
determining that the one or more parameters comprise a threshold resource separation; and
determining the second set of time and frequency resources based at least in part on applying the threshold resource separation after each time and frequency resource of the first set of time and frequency resources.

16. The method of claim 15, wherein the threshold resource separation comprises a threshold number of physical resource blocks or a threshold number of subbands or both.

17. The method of claim 12, further comprising:
determining at least one receive transmission configuration indicator state for the second set of time and frequency resources supporting the full-duplex communication at the UE, wherein the one or more parameters comprise the at least one receive transmission configuration indicator state.

18. The method of claim 17, wherein the at least one receive transmission configuration indicator state indicates an absolute beam direction or a relative beam direction with respect to a current transmit beam direction.

19. The method of claim 12, further comprising:
receiving, from the UE, a reference signal received power threshold; and
determining the second set of time and frequency resources based at least in part on the reference signal received power threshold.

20. The method of claim 12, further comprising:
receiving, from the UE, a distance threshold; and
determining the second set of time and frequency resources based at least in part on the distance threshold.

21. The method of claim 12, wherein the second set of time and frequency resources comprises a subset of the first set of time and frequency resources.

22. The method of claim 12, wherein the UE comprises a subband full-duplex UE or a single frequency full-duplex UE.

23. An apparatus for wireless communication at a first user equipment (UE), comprising:
a processor;
memory coupled to the processor, the processor and memory configured to:
transmit control signaling to reserve a first set of time and frequency resources for a sidelink transmission, the control signaling indicating one or more parameters to be used by a second UE to identify a second set of time and frequency resources for performing a full-duplex communication with the first UE; and
communicate with the second UE based at least in part on the reserved first set of time and frequency resources and the indicated one or more parameters associated with the second set of time and frequency resources.

24. The apparatus of claim 23, further comprising an antenna panel, wherein the processor, the memory and the antenna panel are further configured to:
determine a bitmap comprising a set of bits indicating the second set of time and frequency resources supporting the full-duplex communication, wherein the one or more parameters comprise the second set of time and frequency resources supporting the full-duplex communication.

25. The apparatus of claim 23, wherein the processor and memory are further configured to:
determine the second set of time and frequency resources based at least in part on applying a first resource separation value after a first time and frequency resource of the first set of time and frequency resources and a second resource separation value after a second time and frequency resource of the first set of time and frequency resources, wherein the one or more parameters comprise the first resource separation value and the second resource separation value.

26. The apparatus of claim 23, wherein the processor and memory are further configured to:
determine the second set of time and frequency resources based at least in part on applying a threshold resource separation after each time and frequency resource of the first set of time and frequency resources, wherein the one or more parameters comprise the threshold resource separation.

27. The apparatus of claim 26, wherein the threshold resource separation comprises a threshold number of physical resource blocks or a threshold number of subbands or both.

28. The apparatus of claim 23, wherein the processor and memory are further configured to:
determine at least one receive transmission configuration indicator state for the second set of time and frequency resources supporting the full-duplex communication at the first UE, wherein the one or more parameters comprise the at least one receive transmission configuration indicator state.

29. An apparatus for wireless communication, comprising:
a processor;
memory coupled to the processor, the processor and memory configured to:
receive, from a UE, control signaling to reserve a first set of time and frequency resources for a sidelink transmission, the control signaling indicating one or more parameters to be used to identify a second set of time and frequency resources for performing a full-duplex communication with the UE; and
communicate with the UE based at least in part on the indicated one or more parameters associated with the second set of time and frequency resources.

30. The apparatus of claim 29, further comprising an antenna panel, wherein the processor, the memory and the antenna panel are further configured to:
determine a bitmap comprising a set of bits indicating the second set of time and frequency resources supporting the full-duplex communication, wherein the one or more parameters comprise the set of bits indicating the second set of time and frequency resources supporting the full-duplex communication.
